(19) United States
(12) Patent Application Publication
(10) Pub. No.: US 2011/0062737 A1
(43) Pub. Date: Mar. 17, 2011

(54) MOTOR VEHICLE REAR SEAT

(76) Inventor: Gregor Kroener, Bischberg (DE)

(21) Appl. No.: 12/880,019

(22) Filed: Sep. 10, 2010

(30) Foreign Application Priority Data
Sep. 11, 2009 (DE) 10 2009 040 921.1

(51) Int. Cl. B60N 2/10; B60N 2/20; G06F 19/00

(52) U.S. Cl. 296/65.08; 297/378.1; 297/330; 297/378.12; 701/49

(57) ABSTRACT

A rear seat for a motor vehicle with a seat part and a backrest which is upright in a seating position and folded down in a loading position, and in the loading position increases the loading space floor with its rear side facing a loading space of the motor vehicle is provided. The seat part is connected with at least one electromotive drive for translatorily adjusting and/or folding down the seat part from the seating position into the loading position and for translatorily returning and/or folding back the seat part from the loading position into the seating position.

### REFERENCE TO RELATED APPLICATION

This application claims priority to and the benefit of German Patent Application No. 10 2009 040 921.1 filed on Sep. 11, 2009 and is fully incorporated herein by reference.

### BACKGROUND

This invention relates to a rear seat for a motor vehicle with a seat part and a backrest.

Such rear seat comprises a seat part which consists of a seat base and a seat pan with a cushion arranged thereon, extends in longitudinal direction of the seat and forms a seating surface for a passenger, as well as a backrest which is upright in a seating position, i.e. aligned vertical to the longitudinal direction of the seat or inclined backwards with respect to the vertical, and serves to support the back region of the passenger.

To increase the loading area of a loading space located behind the rear seat, the backrest can be folded forwards onto the seating surface of the seat part, so that it extends in longitudinal direction of the seat. To keep the loading floor increased in this way continuously flat without a step, the seat part is adjusted into a well of the body floor arranged before the seat part before or during folding of the backrest, so that the rear side of the backrest forms a continuously flat loading area with the loading floor of the loading space.

Alternatively, the backrest can be folded forwards onto the seating surface, and the seat part together with the backrest can be folded forwards about a swivel axis extending along the front edge of the seat part, so that it is in a position extending parallel to the backrest of the front seat. In a further alternative, the backrest and the seat part can be folded forwards separately, so that in the loading position the seat part extends substantially parallel to the backrest of the front seat, while the backrest rests on the body surface located below the seat part in the seating position of the rear seat and with its flat rear surface forms a flat and horizontally extending enlargement of the loading floor.

In all variants for increasing the loading area by folding down the backrest of a rear seat, a plurality of separate operations are required, so that folding the rear seat from the seating position into the loading position and from the loading position into the seating position each involves a considerable effort.

Alternatively, the swivel movement of the backrest and the translatory or swivel movement of the seat part for folding the rear seat can be coupled with each other mechanically, so that the backrest is swiveled along with or after translatorily adjusting or swiveling the seat part from the seating position into the loading position or from the loading position.

Both for separate handling and during the coupled adjustment of the rear seat from the seating position into the loading position or from the loading position in the seating position a multitude of mechanical adjusting and locking elements such as locking levers, connecting levers, spring elements to support the adjusting movements, coupling levers for a coupled adjustment of the backrest and the seat part, latches and the like are required. Because of the considerable adjustment forces and to avoid injuries during adjustment of the rear seat from the seating position into the loading position and vice versa, the mechanical adjusting, locking and coupling levers are made of a high-strength material such as steel with a corresponding dimensioning, so that the entire adjustment mechanism has a considerable weight.

In addition, to prevent the backrest or the seat part from being swiveled backwards or folded forwards unintentionally during the adjustment process and to avoid the involved risk of accident, suitable precautions are required to achieve self-blocking or balancing of the backrest and the seat part during the entire adjustment process.

To exclude that body parts or objects are squeezed during adjustment of the rear seat from the seating position into the loading position and from the loading position into the seating position, the adjustable elements are provided with spring elements which upon collision of the seat part or the backrest with a body part or an object absorb the occurring squeezing force and limit the same to an admissible value. These additional spring elements provided for an anti-squeeze protection also increase the weight and the space requirement for the adjusting means.

### SUMMARY

Therefore, it is the object underlying the present invention to create a rear seat as mentioned above, which with a minimum of additional weight for the adjusting device is adjustable with easy handling and a maximum of safety during the adjustment process from a seating position into a loading position and from the loading position into the seating position while ensuring an efficient anti-squeeze protection.

The solution in accordance with the invention provides a rear seat for a motor vehicle, which with a minimum of additional weight for the adjusting device is adjustable with easy handling and a maximum of safety during the adjustment process from a seating position into a loading position and from the loading position into the seating position while ensuring an efficient anti-squeeze protection.

The solution in accordance with the invention is based on the consideration that when using one or more electromotive drives the numerous adjusting, locking and anti-squeeze protection elements of a mechanical adjusting means, which involve a considerable weight and space requirement, are omitted and the self-blocking of an electromotive drive is utilized for a safe adjustment and locking of the seat part and the backrest in the seating and loading positions. In addition, when using one or more electromotive drives an anti-squeeze protection control known for electromotive drives can be used, which makes additional mechanical anti-squeeze protection devices superfluous and hence not only saves further weight, but can also be adjusted very much more precisely than a mechanical anti-squeeze protection device, so that a maximum admissible squeezing force is not exceeded in any phase of the adjustment of the seat part and/or the backrest.

Beside a considerable saving of weight and reduction of the space required for the adjusting means for adjusting a rear seat from a seating position into a loading position and from the loading position into the seating position, the handling during adjustment of the rear seat from the seating position into the loading position and vice versa is simplified considerably or automated completely and at the same time safety is increased during adjustment of the rear seat while maintaining an efficient anti-squeeze protection.

It then is possible to either connect the seat part only with at least one electromotive drive for the translatory adjustment and/or folding of the seat part from the seating position into the loading position and for the translatory return and/or folding back of the seat part from the loading position into the seating position, or both the backrest and the seat part are equipped with an electromotive drive for adjusting the rear seat from the seating position into the loading position and vice versa.

To optimize the loading floor surface and maintain a flat loading floor, the seat part is
translatorily adjustable and lowerable in a combined movement from the seating position into a well molded in the body floor of the motor vehicle, in that it is for example translatorily adjustable from the seating position in the direction of the well molded in the body floor of the motor vehicle or in the direction of the foot space located before the rear seat and subsequently can be lowered into the well or the foot space, or
can be swiveled into a position extending substantially parallel to the backrest of the front seat from the seating position into the loading position, in that before or after swiveling it can be lowered in the position extending substantially parallel to the backrest (11) of the front seat (1).

By means of these adjusting movements it is ensured that the backrest of the rear seat can be folded down to a corresponding extent and the rear surface of the back rest forms a stepless continuation of the loading floor.

In addition, the backrest can also be connected with an electromotive drive for folding the backrest down from the seating position into the loading position and for erecting the backrest from the loading position into the seating position, or an existing electromotive drive can be utilized for inclination adjustment of the backrest for folding down and erecting the backrest of the rear seat.

In a combined adjusting movement, the backrest can be folded about its lower region adjacent to the seat part and the seat part can be swiveled about its front edge in longitudinal direction of the seat, wherein the swivel movement of the backrest and of the seat part (20) for folding down the rear seat are coupled with each other via the electromotive drives of the backrest and of the seat part such that simultaneously with or after swiveling the seat part into a position extending substantially parallel to the backrest of a front seat of the motor vehicle the backrest is folded forwards from the seating position into the loading position.

For initiating the adjustment of a rear seat from the seating position into the loading position and for returning the rear seat from the loading position into the seating position a trigger switch is used for activating the electromotive drives, which is arranged in the swivel region of the backrest and is actuated when manually swiveling the backrest forward or backward by a predeterminable angle from the seating position and/or the loading position, so that only a minimum handling is required for an operator, in order to adjust the rear seat from the seating position into the loading position and vice versa.

Alternatively, a trigger switch can be arranged on the instrument panel and/or in an operating console positioned in the loading space. In this variant, the entire adjusting movement of the rear seat is effected without manual intervention, so that a maximum comfort is ensured during the adjustment.

In a further alternative, a trigger switch for activating the electromotive drive can be arranged on a backrest fitting of the backrest and preferably be connected with an unlocking means of the backrest.

For folding down the backrest and for translatorily adjusting and/or swiveling the seat part, an individual electromotive drive or a plurality of electromotive drives can be provided depending on the type of adjusting movement. Due to the small space requirement of an electromotive drive, an allocation of individual electromotive drives to the different parts to be adjusted of the backrest or the seat part is possible without a significant increase in weight of the adjusting means. Alternatively, however, a plurality of adjustable elements can also be connected with an electromotive drive for a combined adjustment. The coupling elements required for this purpose only minimally increase the total weight of the adjusting means, since due to the self-blocking of the electromotive drive no locking and balancing means and additional mechanical anti-squeeze protection devices are required.

Exemplary, the electromotive drives of the backrest and of the seat part are connected with an electronic control system, which after actuation of the trigger switch initiates a sequence control for swiveling the backrest forwards and backwards or for folding down or translatorily adjusting the seat part.

By adjusting the seat part and/or the backrest by means of an electromotive drive, the condition is created for actuating the electromotive drive by an electronic control system which can be coupled with an electronic control system provided for adjusting the front seats or can be integrated in a central control and regulating means of the motor vehicle or into a subsystem provided for the seat adjustments, which via a bus system can be connected with the electromotive drive of the seat part and/or the backrest, so that the expenditure of hardware for actuating the electromotive drive for the adjustment of the backrest and/or the seat part of a rear seat is minimal.

To ensure an efficient anti-squeeze protection, the electronic control system can be provided with an anti-squeeze protection control means which upon detection of a squeezed condition stops or reverses the electromotive drive.

In a further exemplary aspect, the anti-squeeze protection control means continuously detects input variables of the electromotive drive for the backrest and/or the seat part and via equation systems, which were detected by means of a mathematical model of the adjustment mechanism and of the electromotive drive, determines the current load of the adjustment mechanism or the electromotive drive, so that upon exceedance of a predetermined load limit the electromotive drive is switched off or controlled to a value below the load limit.

To ensure an efficient anti-squeeze protection, the electromotive drive for the backrest and/or the seat part alternatively exerts an adjustment force which is equal to the sum of the force required for adjusting the backrest and/or the seat part and an excess force which is smaller than or equal to an admissible squeezing force.

### BRIEF DESCRIPTION OF THE DRAWINGS

With reference to several embodiments illustrated in the drawing the idea underlying the invention and further possible variants of the solution in accordance with the invention will be explained in detail.

FIG. 1 shows a schematic representation of a front and rear seat arrangement of a motor vehicle with electromotive drives for seat adjustment of the front seat and for adjusting the rear seat from a seating position into a loading position and an electronic control system for actuating the electromotive drive means.

FIG. 2A shows a schematic representation of a front and rear seat arrangement, wherein the rear seat is in a seating position.

FIG. 2B shows a schematic representation of a phase of movement when folding forwards and translatorily adjusting the rear seat according FIG. 2A from the seating position into a loading position.

FIG. 2C shows a schematic representation of a phase of movement when folding forwards and translatorily adjusting the rear seat according FIG. 2A from the seating position into the loading position.

FIG. 2D shows a schematic representation of the rear seat according FIG. 2A, wherein the rear seat is in the loading position.

FIG. 3 shows a schematic side view of a rear seat with separate, electromotively driven folding and swivel movements of the backrest and the seat part.

FIG. 4 shows a schematic block diagram for controlling and regulating a plurality of adjusting means of a motor vehicle, which are connected with a central control and regulating means via a bus system.

### DETAILED DESCRIPTION

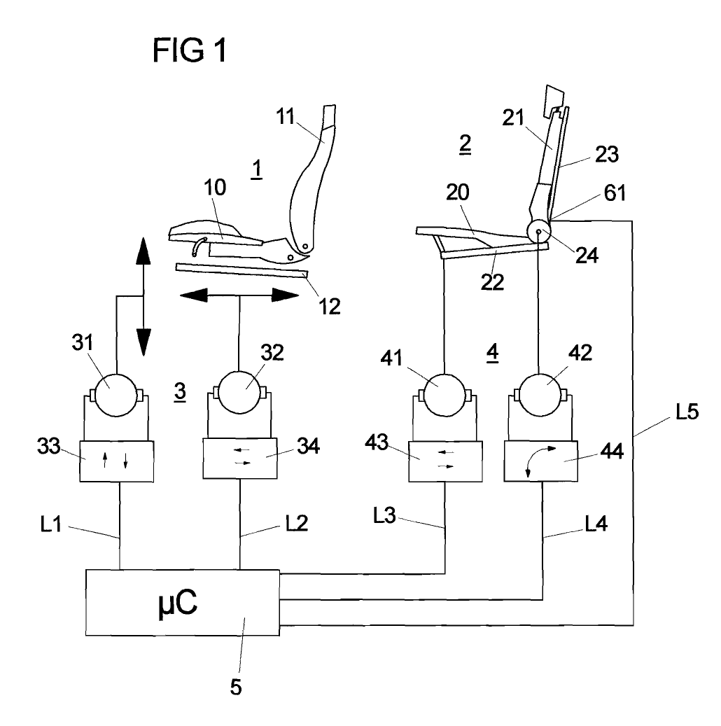

The seat arrangement shown in FIG. 1 shows a schematic side view of a front seat 1 with a seat part 10 longitudinally adjustable on adjusting rails 12, to which seat part a backrest 11 is pivotally attached for adjusting different backrest inclinations. In direction of travel of the motor vehicle behind the front seat 1 a rear seat 2 is arranged, which likewise is composed of a seat part 20 and a backrest 21. The seat part 20 is connected with the body floor of the motor vehicle, firmly or via a rail arrangement 22, for longitudinal adjustment of the rear seat 2. The backrest 21 is selectively articulated to the seat part 20 or to the body floor via a backrest fitting 24.

In direction of travel of the motor vehicle behind the rear seat 2 a loading space is provided, which in a seating position of the rear seat 2 as shown in FIG. 1 is closed by a rear surface 23 of the backrest 21. The rear surface 23 generally is formed flat, so that during adjustment of the rear seat 2 from the seating position shown in FIG. 1 into a loading position with substantially horizontally aligned backrest 21, the rear surface 23 forms a rather stepless continuation of the loading space floor. For this purpose, the rear surface 23 has a stability which satisfies a corresponding load when packing the loading space.

When swiveling the backrest 21 from the seating position into the loading position, a trigger switch 61 is arranged in the swivel region of the backrest 21, which is actuated by the backrest 21 or a trigger element arranged in the backrest fitting 24 and emits a control signal, when the backrest 21 is manually swiveled from the seating position. Alternatively, the trigger switch 61 for activating the electromotive drive can be arranged on a backrest fitting in the upper region of the backrest or an unlocking lever of the backrest can be employed or utilized as a trigger switch. In a further alternative, the trigger switch can be arranged on the instrument panel and/or in an operating console positioned in the loading space, so that the entire adjusting movement of the rear seat is effected without manual intervention and hence a maximum ease of operation is ensured during adjustment.

A second trigger switch can also be arranged in the swivel region of the backrest 21 or a backrest fitting 24 can be arranged in an angular position which is adjacent to the loading position of the rear seat 2, so that when first manually returning the rear seat from a loading position into the seating position shown in FIG. 1, the second trigger switch is actuated and emits a corresponding control signal which initiates the electromotively driven return of the rear seat 2 into the seating position.

For adjusting the front seat 1 in longitudinal or X direction of the motor vehicle and for height adjustment, the front seat 1 is connected with an electromotive drive means 3 which includes an electromotive drive 31 for the height adjustment of the front seat 1 and an electromotive drive 32 for the longitudinal adjustment of the front seat 1. Further adjusting means, such as for example an inclination adjustment of the seat part 10 of the front seat 1 or an inclination adjusting means of the backrest 11 of the front seat, are not shown in greater detail.

The electromotive drives 31, 32 of the electromotive drive means 3 for the front seat 1 are connected with an electronic control system 5 via actuators 33, 34. The actuators 33, 34 are formed for example as a relay circuit or transistor circuit, whose control terminals are connected with the electronic control system 5 and to whose load terminals the on-board voltage of the motor vehicle is applied. In dependence on the control signals emitted by the electronic control system 5, the electromotive drives 31, 32 of the electromotive drive means 3 are operated in the one or other direction of rotation, such that the front seat 1 is moved forwards or backwards and lifted or lowered, respectively, in longitudinal direction of the motor vehicle.

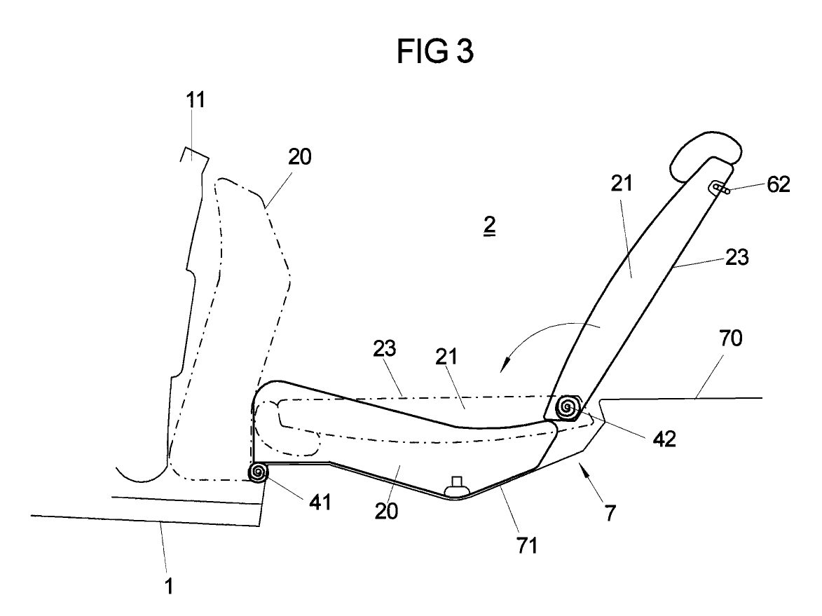

In accordance with the invention, the rear seat 2 also is connected with an electromotive drive means 4 which includes at least one electromotive drive 41, 42 connected with the seat part 20 and with the backrest 21, respectively. The electromotive drive 41 connected with the seat part 20 effects a translatory adjustment of the seat part 20 or, in an alternative embodiment schematically shown in FIG. 3, a swivel movement of the seat part 20 about a swivel axis adjacent to the front edge of the seat part 20, so that in the swiveled condition the seating surface of the seat part 20 rests against the rear side of the backrest 11 of the front seat 1.

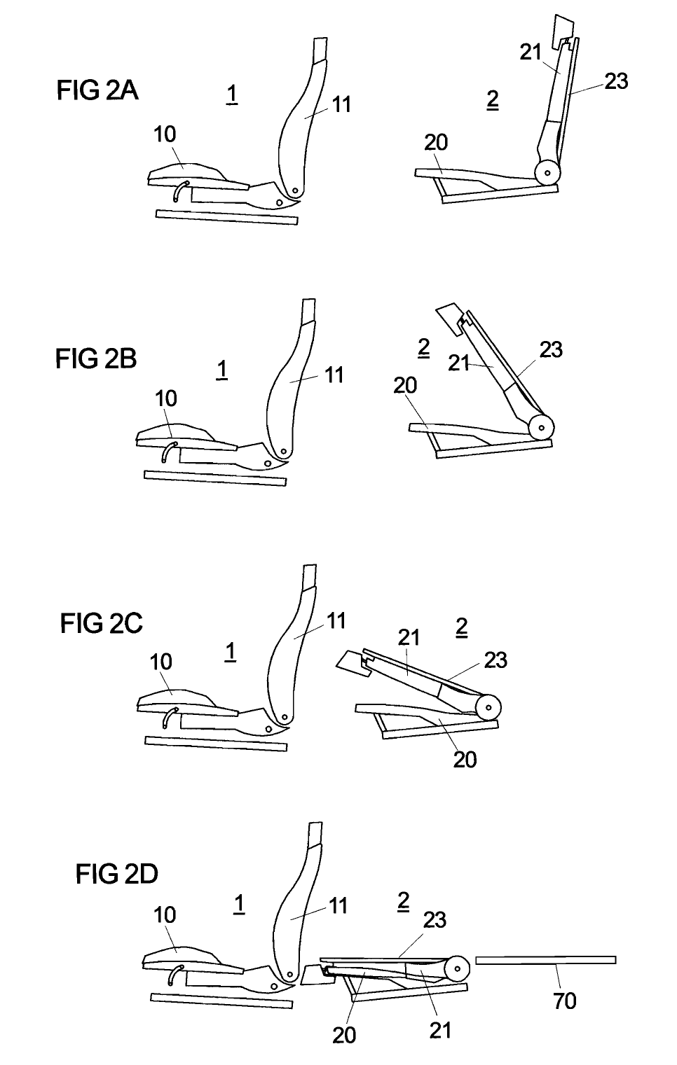

The electromotive drive 42 effects a swivel movement of the backrest 21 about the backrest fitting 24 from the seating position shown in FIG. 2A into a loading position shown in FIG. 2D or serves for swiveling back from the loading position corresponding to FIG. 2D into the seating position corresponding to FIG. 2A.

The electromotive drives 41, 42 are connected with the electronic control system 5 via actuators 43, 44 and lines L3, L4. In addition, the trigger switch 6 likewise is connected with the electronic control system 5 via a control line L5.

When triggering the trigger switch 6 either by manual actuation of the trigger switch 6 or by swiveling the backrest 21 by a specified angle from the seating position and/or the loading position, the trigger switch 6 emits a control signal to the electronic control system 5 via line L5, which electronic control system then emits control signals via lines L3, L4 to the actuators 43, 44 for actuating the electromotive drives 41, 42 of the electromotive drive means 4 of the rear seat 2, which thereupon are operated in the one or other direction of rotation and for example actuate a pinion for longitudinal adjustment or for swiveling the seat part 20 about a swivel axis or for folding the backrest 21 forwards or backwards from the seating position into the loading position or from the loading position into the seating position.

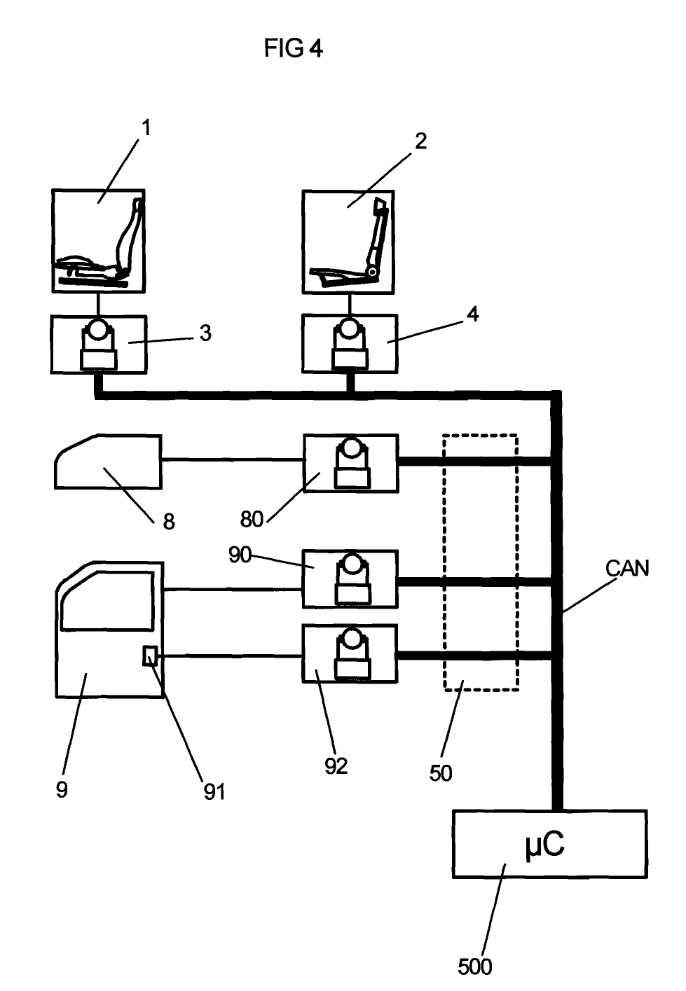

FIG. 1 shows a coupling of the electromotive drive means 3, 4 of the front seat 1 and rear seat 2 for reducing the expenditure of hardware as compared to a separate electronic control system for the front seat 1 and the rear seat 2. This synergy effect can even be increased further by integrating the electronic control system for the rear seat 2 into a subsystem, for example into a door control unit of a motor vehicle or into a central control and regulating means—as shown schematically in FIG. 4.

With reference to the schematic representations in FIGS. 2 and 3 two different variants will be explained during adjustment of a rear seat from a seating position into a loading position.

In the variant shown in FIGS. 2A to 2D, folding the backrest 21 forwards is shown with a translatory adjustment of the seat part 20 of the rear seat 2 for moving the rear seat 2 into a lowered position, in which the rear surface 23 of the backrest 21 forms a stepless, horizontal continuation of the loading space floor for an obstacle-free packing of the loading space.

FIG. 2A shows the rear seat 2 in the seating position, in which the backrest 21 forms an obtuse or right angle with the seating surface of the seat part 20. By actuating a trigger switch 61 as shown in FIG. 1, a trigger switch 62 as shown in FIG. 3, or by manually swiveling the backrest 21 into an angular position as shown in FIG. 2B, the trigger switch 61 emits a signal to the electronic control system 5 which initiates the electromotive drive means 4 of the rear seat 2 via the lines 3, 4, in that first the electromotive drive 42 is actuated for further folding forwards the backrest 21, or in a combined adjusting movement both the electromotive drive 41 is actuated for translatorily adjusting the seat part 20 and the electromotive drive 42 is actuated for further folding forwards the backrest 21 as shown in FIG. 2C.

At the end of the adjusting movement, the seat part 20 together with the backrest 21 is in an advanced position and the backrest 21 is in a position folded forwards, in which the rear surface 23 of the backrest 21 forms a flat, stepless continuation of the loading space floor, corresponding to the loading position schematically illustrated in FIG. 2D.

When returning the rear seat 2 from the loading position shown in FIG. 2D into the seating position shown in FIG. 2A, the adjusting movements of the seat part 20 and of the backrest 21 occur in reverse order, wherein in the variant of folding the backrest 21 forwards by a specified angle for initiating the trigger switch 61 a stop defining the inclination of the backrest 21 terminates either the adjusting movement of the electromotive drive means 4 or the renewed actuation of the trigger switch 61, in order to start the adjustment from the seating position.

FIG. 3 shows an adjusting variant of the rear seat 2 in a schematic side view of the rear seat 2 in relation to the backrest 11 of the front seat 1. In this adjusting variant, the backrest 21 can be folded about its lower region adjacent to the seat part 20 or about the backrest fitting 24 as shown in FIG. 1, while the seat part 20 can be swiveled about its front edge in longitudinal direction of the seat, wherein the swivel movements of the backrest 21 and of the seat part 20 for folding down the rear seat 2 are effected either independent of each other or coupled with each other such that simultaneously with or after swiveling the seat part 20 into a position extending substantially parallel to the backrest 11 of the front seat 1 the backrest 21 is folded forwards from the seating position into the loading position.

For folding down the rear seat 2 from the seating position illustrated in continuous lines into the loading position illustrated in dash-dotted lines, after actuation of a trigger switch 62 arranged on the upper backrest fitting and connected for example with the backrest latch or after manually folding the backrest 21 forwards by a specifiable swivel angle, the electromotive drive means 4 as shown in FIG. 1 is initiated by the electronic control system by emitting a sensor signal via line L5, and the seat part 20 is swiveled by means of the electromotive drive 41 from a well 71 of the body floor 7 about the swivel axis arranged at the front edge of the seat part 20 into the dash-dotted loading position or is first lowered and then swiveled into the loading position.

Subsequently, or combined with the swivel movement of the seat part 20, the electromotive drive 42 actuating the backrest 21 is initiated, which folds the backrest 21 forwards into the dash-dotted loading position in which the headrest connected with the backrest 21 rests against the bottom surface of the seat part 20 and the rear surface 23 of the backrest 21 forms a stepless continuation of the loading floor 70.

Returning the rear seat 2 from the dash-dotted loading position into the seating position illustrated in continuous lines is effected in reverse order.

In an alternative embodiment to an actuation of the electromotive drive means 3, 4 of the front seat 1 and of the rear seat 2 by means of a common electronic control system 5 corresponding to the schematic representation of FIG. 1, the actuation of the electromotive drive means 3, 4 for the front seat 1 and the rear seat 2 is possible via a subsystem or via a central control and regulating means 500 of the motor vehicle as schematically shown in FIG. 4.

In the schematic representation as shown in FIG. 4, a plurality of adjusting means such as the adjusting means for a front seat 1, a rear seat 2, a window lift 8, a motor vehicle door 9 and a door lock 91 are shown, whose electromotive drive means 3, 4, 80, 90, 92 are connected with a central control and regulating means 500, which for example consists of a programmable microcomputer, via a bus system CAN.

Alternatively, the control lines for the electromotive drive means 80, 90, 92 can be combined in the motor vehicle door via a door control unit 50 illustrated in broken lines, which is connected with the bus system CAN.

In a manner known per se, the central control and regulating means 500 includes programs for the various sequence controls of the adjusting means 1, 2, 8, 9, 91 and programs for an anti-squeeze protection control for the electromotive drive means 3, 4, 80, 90, 92 of the adjusting means 1, 2, 8, 9, 91, possibly in conjunction with corresponding characteristic curve controls.

Both the electronic control system 5 as shown in FIG. 1 and the central control and regulating means 500 or the subsystem in the form of a door control unit 50 as shown in FIG. 4 include an anti-squeeze protection control which ensures that in the case of a collision of the adjusting means 1, 2, 8, 9 with objects or body parts of a passenger a specified maximum squeezing force is not exceeded.

The anti-squeeze protection control can be effected by means of corresponding sensors in the region of the adjusting means or alternatively by means of a mathematical model of the adjusting means, with which the relations between the respective force components of the adjusting systems are taken into account and the load acting on the adjusting means or the electromotive drive and hence the squeezing force can exactly be calculated therefrom. The summarizing term adjusting means here is meant to include all components of an adjusting system which are necessary for the operation of the adjusting means, for example the seat part or the backrest of a rear seat as component to be adjusted, the guide rails for translatorily adjusting the seat part, the electromotive drives and the units for forwarding the drive force of the electromotive drives.

A preferred embodiment of the anti-squeeze protection control consists in an excess force limitation, wherein excess force is defined to be that force which exceeds an adjustment force required for adjusting the respective adjustable part, so that without a corresponding excess force under the sole influence of the adjustment force the adjustable part will stop at each position of the adjustment path or adjustment angle even in consideration of external influences. When the excess force is limited to a value which at each point of the translatory or rotatory adjustment path is smaller than or equal to an admissible squeezing force, it is ensured that no inadmissible forces act on a squeezed object or a squeezed body part.

1. A rear seat for a motor vehicle having a loading space and a loading space floor, the rear seat being adapted to be adjusted by at least one electromotive drive, the rear seat comprising:
a seat part; and
a backrest having a rear side, the backrest being upright in a seating position and folded down in a loading position, and in the loading position increasing the loading space floor with its rear side facing the loading space of the motor vehicle, wherein the seat part is connected with at least one electromotive drive for at least one of translatorily adjusting and folding the seat part from the seating position into the loading position and for at least one of translatorily returning and folding back the seat part from the loading position into the seating position.

2. The rear seat according to claim 1, wherein the seat part is translatorily adjustable and lowerable in a combined movement from the seating position into a well molded in a body floor of the motor vehicle.

3. The rear seat according to claim 1, wherein the seat part is translatorily adjustable in a direction of a well molded in a body floor of the motor vehicle and subsequently lowerable into the well.

4. The rear seat according to claim 1, wherein from the seating position into the loading position the seat part is configured to be swiveled into a position extending substantially parallel to a backrest of a front seat of the motor vehicle.

5. The rear seat according to claim 4, wherein before or after being swiveled the seat part can be moved in the position extending substantially parallel to the backrest of the front seat.

6. The rear seat according to claim 1, wherein the backrest is connected with an electromotive drive for folding down the backrest from the seating position into the loading position and for erecting the backrest from the loading position into the seating position.

7. The rear seat according to claim 5, wherein the backrest has a lower region adjacent to the seat part, and the backrest is configured to be folded about its lower region adjacent to the seat part and the seat part is configured to be swiveled about a front edge in a longitudinal direction of the rear seat, wherein the swivel movement of the backrest and of the seat part for folding down the rear seat are coupled with each other via the electromotive drives of the backrest and of the seat part such that simultaneously with or after swiveling the seat part into a position extending substantially parallel to a backrest of a front seat of the motor vehicle the backrest is folded forwards from the seating position into the loading position.

8. The rear seat according to claim 1, further comprising a trigger switch for activating the electromotive drive, which trigger switch is arranged in a swivel region of the backrest and is actuated when manually swiveling the backrest from at least one of the seating position and the loading position by a specifiable angle.

9. The rear seat according to claim 1, further comprising a trigger switch arranged on a backrest fitting of the backrest for activating the at least one electromotive drive.

10. The rear seat according to claim 9, wherein the trigger switch is connected with an unlocking means of the backrest.

11. The rear seat according to claim 1, further comprising a trigger switch arranged on at least one of an instrument panel and an operating console positioned in the loading space.

12. The rear seat according to claim 6, wherein the electromotive drive connected with at least one of the backrest and the seat part is connected with an electronic control system which after actuating a trigger switch initiates a sequence control for swiveling the backrest forwards and backwards and for folding down or translatorily adjusting the seat part, respectively.

13. The rear seat according to claim 12, wherein the electronic control system is integrated in a central control and regulating system of the motor vehicle, which is connected with at least one of the electromotive drive of the backrest and the seat part via a bus system of the motor vehicle.

14. The rear seat according to claim 13, wherein the central control and regulating system of the motor vehicle constitutes a central motor vehicle control unit which is connected with the electromotive drives of a plurality of adjustment mechanisms of the motor vehicle via the bus system.

15. The rear seat according to claim 14, wherein the electronic control system is integrated in a subsystem which is connected with a part of the electromotive drives for the adjustment mechanisms of the motor vehicle and with the central motor vehicle control unit via the bus system.

16. The rear seat according to claim 1, further comprising an anti-squeeze protection controller which upon detection of a squeezed condition stops or reverses the at least one electromotive drive and is integrated in an electronic control system, and an anti-squeeze protection control for the front seats of the motor vehicle, and is integrated into a subsystem or into a central motor vehicle control unit.

17. The rear seat according to claim 12, wherein input variables of the electromotive drive for at least one of the backrest and the seat part are detected continuously and via equation systems, which are detected by a mathematical model of an adjustment mechanisms of the motor vehicle and of the electromotive drive, a current load of the adjustment mechanism or the electromotive drive being determined and upon exceedance of a predetermined load limit, the electromotive drive being switched off or controlled to a value below the predetermined load limit.

18. The rear seat according to claim 12, wherein the electromotive drive for at least one of the backrest and the seat part exerts an adjustment force which is equal to a sum of the force required for adjusting at least one of the backrest and the seat part and an excess force which is smaller than or equal to an admissible squeezing force.
